(19) United States
(12) Patent Application Publication
(10) Pub. No.: US 2018/0232621 A1
(43) Pub. Date: Aug. 16, 2018

(54) OPERATION DEVICE AND METHOD FOR CONVOLUTIONAL NEURAL NETWORK

(71) Applicant: Kneron, Inc., San Diego, CA (US)

(72) Inventors: Yuan DU, Los Angeles, CA (US); Li DU, La Jolla, CA (US); Chun-Chen LIU, San Diego, CA (US)

(21) Appl. No.: 15/801,887

(22) Filed: Nov. 2, 2017

(30) Foreign Application Priority Data
Feb. 10, 2017 (TW) 106104513

(51) Int. Cl. G06N 3/00; G06F 5/01; G06F 7/50

(52) U.S. Cl. CPC G06N 3/004; G06F 7/50; G06F 5/01

(57) ABSTRACT

An operation method for a convolutional neural network includes the following steps of: performing an add operation with a plurality of input data to output an accumulated result; performing a bit-shift operation with the accumulated result to output a shifted result; and performing a weight-scaling operation with the shifted result to output a weighted result. Herein, a weighting factor of the weight-scaling operation is determined according to the amount of input data, the amount of right-shifting bits in the bit-shift operation, and a scaled weight value of a consecutive layer in the convolutional neural network.

### CROSS REFERENCE TO RELATED APPLICATIONS

This Non-provisional application claims priority under 35 U.S.C. § 119(a) on Patent Application No(s). 106104513 filed in Taiwan, Republic of China on Feb. 10, 2017, the entire contents of which are hereby incorporated by reference.

### BACKGROUND OF THE INVENTION

### Field of Invention

The present disclosure relates to an operation method for a convolutional neural network and, in particular, to a device and a method for performing average pooling operation.

### Related Art

Convolutional neural network (CNN) is a feedforward neural network and usually includes a plurality of convolution layers and pooling layers. The pooling layers can perform max pooling operations or average pooling operations with respective to the specific characteristics of a selected area in the inputted data, thereby reducing the amount of parameters and the operations in the neural network. In the average pooling operation, it generally performs an add operation and then performs a division operation to process the sum result. However, the division operation needs more performances of the processor, which may easily cause the overloading of the hardware resources. Besides, the overflow issue may occur when performing the add operation of a plurality of data.

Therefore, it is desired to provide a pooling operation method for performing the average pooling operation with less performances of the processor.

### SUMMARY OF THE INVENTION

In view of the foregoing, an objective of the disclosure is to provide a convolution operation device and a pooling operation method that can prevent the overloading of hardware resources and increasing the pooling operation efficiency.

An operation method for a convolutional neural network includes the following steps of: performing an add operation with a plurality of input data to output an accumulated result; performing a bit-shift operation with the accumulated result to output a shifted result; and performing a weight-scaling operation with the shifted result to output a weighted result. Herein, a weighting factor of the weight-scaling operation is determined according to an amount of the input data, an amount of right-shifting bits in the bit-shift operation, and a scaled weight value of a consecutive layer in the convolutional neural network.

In one embodiment, the weighting factor of the weight-scaling operation is proportional to the scaled weight value and the amount of the right-shifting bits in the bit-shift operation, and is inversely proportional to the amount of the input data, and the weighted result is equal to a product of the shifted result and the weighting factor.

In one embodiment, the amount of the right-shifting bits in the bit-shift operation depends on a size of a pooling window, and the amount of the input data depends on the size of the pooling window.

In one embodiment, the consecutive layer is a next convolution layer in the convolutional neural network, the scaled weight value is a filter coefficient of the next convolution layer, and the add operation and the bit-shift operation are operations in a pooling layer of the convolutional neural network.

In one embodiment, a division operation of the pooling layer is integrated in a multiplication operation of the next convolution layer.

Another operation method for a convolutional neural network includes the following steps of: performing an add operation with a plurality of input data in a pooling layer to output an accumulated result; and performing a weight-scaling operation with the accumulated result in a consecutive layer to output a weighted result. Herein, a weighting factor of the weight-scaling operation is determined according to an amount of the input data and a scaled weight value of the consecutive layer, and the weighted result is equal to a product of the accumulated result and the weighting factor.

In one embodiment, the consecutive layer is a next convolution layer, the scaled weight value is a filter coefficient, the weight-scaling operation is a convolution operation, and the weighting factor of the weight-scaling operation is obtained by dividing the filter coefficient with the amount of the input data.

In one embodiment, the amount of the input data depends on a size of the pooling window.

Another operation method for a convolutional neural network includes the following steps of: multiplying a scaled weight value and an original filter coefficient to produce a weighted filter coefficient; and performing a convolution operation with input data and the weighted filter coefficient in a convolution layer.

In one embodiment, the operation method further includes the following steps of: performing a bit-shift operation with the input data; and inputting the input data processed by the bit-shift operation to the convolution layer. Herein, the scaled weight value depends on an original scaled weight value and an amount of right-shifting bits in the bit-shift operation.

The present disclosure also discloses an operation device for a convolutional neural network that can perform any of the above operation methods.

As mentioned above, the operation device and method of the disclosure can perform the average pooling operation by two steps. The pooling unit only performs the add operation cooperating with the bit-shift operation so as to prevent the data overflow caused in the accumulating procedure. Then, the weight-scaling operation is applied to the output result of the pooling unit to obtain the final average result. Since the pooling unit does not perform the division operation, the required performance of the processor can be reduced so as to increase the pooling operation efficiency.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram showing a part of layers of the convolutional neural network;

FIG. 2 is a schematic diagram showing an integrated operation of the convolutional neural network;

FIG. 3 is a schematic diagram showing a convolutional neural network; and

FIG. 4 is a block diagram showing a convolution operation device according to an embodiment of the disclosure.

### DETAILED DESCRIPTION OF THE INVENTION

The present invention will be apparent from the following detailed description, which proceeds with reference to the accompanying drawings, wherein the same references relate to the same elements.

FIG. 1 is a schematic diagram showing a part of layers of a convolutional neural network. As shown in FIG. 1, the convolutional neural network includes a plurality of operation layers such as the convolution layers and pooling layers. The convolutional neural network may include a plurality of convolution layers and a plurality of pooling layers. The output of each layer can be the input of another layer or a consecutive layer. For example, the output of the Nth convolution layer can be the input of the Nth pooling layer or another consecutive layer, the output of the Nth pooling layer can be the input of the (N+1)th pooling layer or another consecutive layer, and the output of the Nth operation layer can be the input of the (N+1)th operation layer.

In order to enhance the operation performance, the operations of different layers but similar characteristics can be optionally integrated. For example, the pooling operation of the pooling layer is an average pooling operation, and the division calculation can be integrated in the next operation layer. The next operation layer is, for example, a convolution layer, so that the division calculation of the average pooling operation in the pooling layer and the convolution multiplication calculation of the next convolution layer can be performed together. In addition, the pooling layer can perform a shifting operation to replace the needed division calculation of the average pooling operation, and a part of the data, which are not processed with the division calculation yet, can be integrated and calculated in the next operation layer. In other words, a part of the data, which are not processed with the placed shifting operation, can be calculated in the convolution multiplication calculation of the next convolution layer.

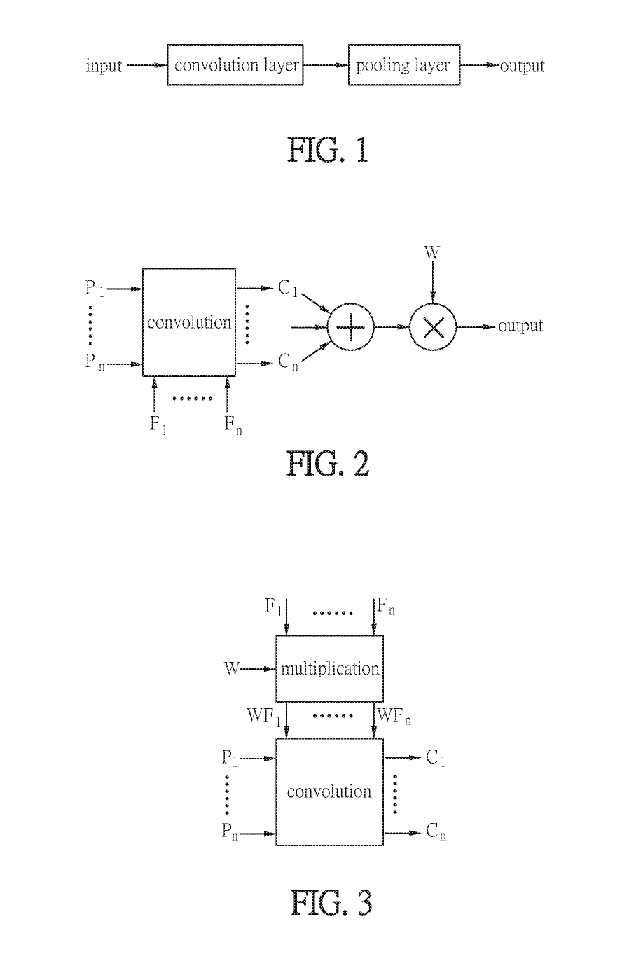

FIG. 2 is a schematic diagram showing an integrated operation of the convolutional neural network. As shown in FIG. 2, in the convolution layer, a plurality of data P1˜Pn and a plurality of filter coefficients F1˜Fn are provided to perform a convolution operation to generate a plurality of data C1˜Cn. The generated data C1˜Cn are provided as a plurality of input data of the pooling layer. In the pooling layer, an add operation is performed to process a plurality of input data to output an accumulated result. In a consecutive layer, a weight-scaling operation is performed to process the accumulated result to output a weighted result. The scaled weight value W of the weight-scaling operation is determined based on the amount of the input data and a scaled weight value of the consecutive layer. The weighted result is a product of the accumulated result and the scaled weight value W.

For example, the consecutive layer is a next convolution layer in the convolutional neural network, the scaled weight value is a filter coefficient of the next convolution layer, and the add operation is a convolution operation. The weighting factor of the weight-scaling operation is obtained by dividing the filter coefficient with the amount of the input data. In addition, the amount of the input data is determined according to the size of the pooling window.

In addition, before the accumulated result is calculated in another layer, a part of the division result can be obtained by shift operation. For example, a bit-shift operation can be performed to process the accumulated result to output a shifted result, and then a weight-scaling operation is performed to process the shifted result to output a weighted result. Herein, a scaled weight value W of the weight-scaling operation is determined according to an amount of the input data, an amount of right-shifting bits in the bit-shift operation, and a scaled weight value of a consecutive layer in the convolutional neural network. The scaled weight value W of the weight-scaling operation is proportional to the scaled weight value and the amount of the right-shifting bits in the bit-shift operation, and is inversely proportional to the amount of the input data. The weighted result is equal to a product of the shifted result and the scaled weight value W.

The amount of the right-shifting bits in the bit-shift operation depends on a size of a pooling window. One right-shifting bit means the result is divided by 2 for once. If the amount of the right-shifting bits is n, 2ⁿ is closest to but not over the size of the pooling window. For example, the size of a 2×2 pooling window is 4, n is 2, which means to right shift for 2 bits. In another case, the size of a 3×3 pooling window is 9, n is 3, which means to right shift for 3 bits.

The amount of the input data is determined based on the size of the pooling window. The consecutive layer is a next convolution layer in the convolutional neural network, the scaled weight value is a filter coefficient of the next convolution layer, and the add operation and the bit-shift operation are operations in a pooling layer of the convolutional neural network.

For example, when one characteristic area includes 9 data to be processed by the average pooling operation, the 9 data are accumulated to obtain an accumulated result. In order to prevent the overflow of the accumulated result, a bit-shift operation can be applied to the accumulated result. For example, the accumulated result can be right shifted for two bits so as to obtain a shifted result. In this case, the accumulated result is divided by 4 to obtain the shifted result. Then, the shifted result is multiplied with a weighting factor to obtain a weighted result. The weighting factor is optionally selected according to the shifting amount of the bit shifting. In this embodiment, the weighting factor is 1/2.25, so that the obtained weighted result is equal to the result of the accumulated result divided by 9. Since the bit-shifting operation and the weight-scaling operation do not occupy too much processing performance, the above operation method including the bit-shifting operation and the weight-scaling operation can allow the processor to perform the average pooling operation with less performance. As a result, the performance for executing the pooling operation can be enhanced.

FIG. 3 is a schematic diagram showing a convolutional neural network. As shown in FIG. 3, the convolution operation of the convolution layer is to multiply the input data with the filter coefficient. When the input data need to be weighted or scaled, the weighting or scaling operation can be integrated in the convolution operation. In other words, the weighting (or scaling) and the convolution operation of the convolution layer can be finished in the same multiplication operation.

The data P1˜Pn inputted to the convolution layer can be the pixel of an image or the output of a previous layer in the convolutional neural network (e.g. a pooling layer or a hidden layer). As shown in FIG. 3, the operation method for a convolutional neural network includes the following steps of: multiplying a scaled weight value W and an original filter coefficients F1˜Fn to produce a weighted filter coefficients WF1˜WFn; and performing a convolution operation with input data P1˜Pn and the weighted filter coefficients WF1˜WFn in a convolution layer. The original convolution operation is to multiply the input data P1˜Pn and the filter coefficients F1˜Fn. In order to integrate the weighting or scaling operation, the weighted filter coefficients WF1˜WFn are used in the operation of the convolution layer instead of the original filter coefficients F1˜Fn. Accordingly, the input of the convolution layer do not need additional multiplication operation for weighting or scaling.

In addition, when the weighting or scaling process needs a division operation, or the weighting or scaling factor is smaller than 1, the operation method can perform a bit-shift operation with the input data and then input the input data processed by the bit-shift operation to the convolution layer. Herein, the scaled weight value W depends on an original scaled weight value and an amount of right-shifting bits in the bit-shift operation. In one example, the original scaled weight value is 0.4, the bit-shift operation is to right shift for one bit (equal to multiply with a factor of 0.5), and the scaled weight value W is 0.8. In this case, the operation result is equal to the product of the input data and the original scaled weight value (0.5*0.8=0.4). In addition, the replacing the division operation by the bit-shift operation can reduce the loading of the hardware, and the input of the convolution layer does not need the additional multiplication operation for performing the weighting or scaling.

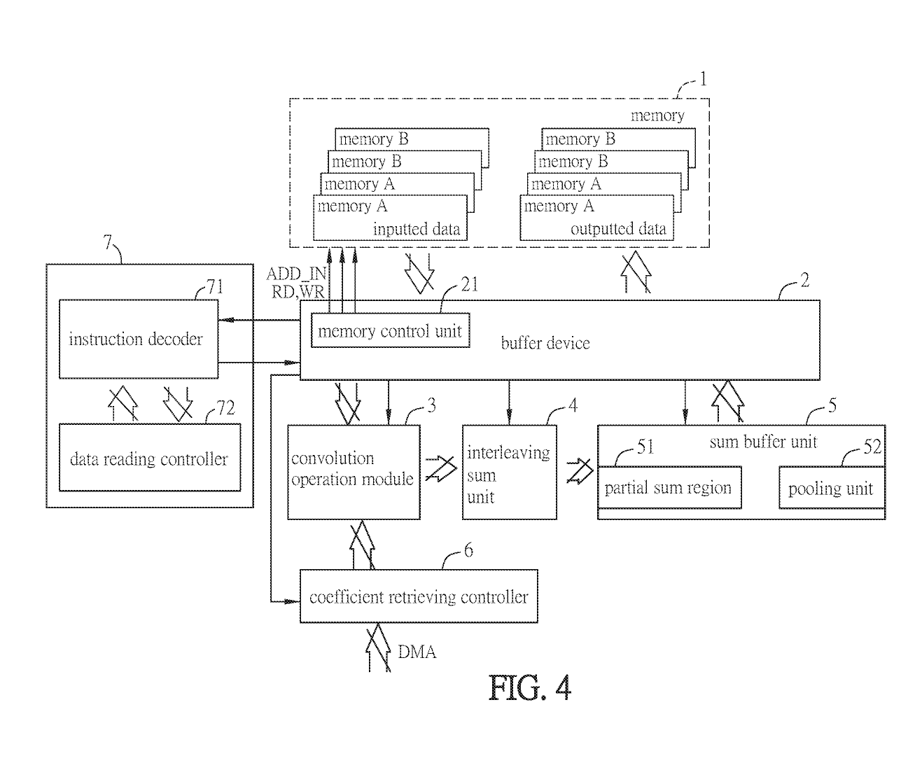

FIG. 4 is a block diagram showing a convolution operation device according to an embodiment of the disclosure. Referring to FIG. 4, the convolution operation device includes a memory 1, a buffer device 2, a convolution operation module 3, an interleaving sum unit 4, a sum buffer unit 5, a coefficient retrieving controller 6 and a control unit 7. The convolution operation device can be applied to convolutional neural network (CNN).

The memory 1 stores the data for the convolution operations. The data include, for example, image data, video data, audio data, statistics data, or the data of any layer of the convolutional neural network. The image data may contain the pixel data. The video data may contain the pixel data or movement vectors of the frames of the video, or the audio data of the video. The data of any layer of the convolutional neural network are usually 2D array data, such as 2D array pixel data. In this embodiment, the memory 1 is a SRAM (static random-access memory), which can store the data for convolution operation as well as the results of the convolution operation. In addition, the memory 1 may have multiple layers of storage structures for separately storing the data for the convolution operation and the results of the convolution operation. In other words, the memory 1 can be a cache memory configured in the convolution operation device.

All or most data can be stored in an additional device, such as another memory (e.g. a DRAM (dynamic random access memory)). All or a part of these data are loaded into the memory 1 from the another memory when executing the convolution operation. Then, the buffer device 2 inputs the data into the convolution operation module 3 for executing the convolution operations. If the inputted data are from the data stream, the latest data of the data stream are written into the memory 1 for the convolution operations.

The buffer device 2 is coupled to the memory 1, the convolution operation module 3 and a part of the interleaving buffer unit 5. In addition, the buffer device 2 is also coupled to other components of the convolution operation device such as the interleaving sum unit 4 and the control unit 7. Regarding to the image data or the frame data of video, the data are processed column by column and the data of multiple rows of each column are read at the same time. Accordingly, within a clock, the data of one column and multiple rows in the memory 1 are inputted to the buffer device 2. In other words, the buffer device 2 is functioned as a column buffer. In the operation, the buffer device 2 can retrieve the data for the operation of the convolution operation module 3 from the memory 1, and modulate the data format to be easily written into the convolution operation module 3. In addition, the buffer device 2 is also coupled with the sum buffer unit 5, the data processed by the sum buffer unit 5 can be reordered by the buffer device 2 and then transmitted to and stored in the memory 1. In other words, the buffer device 2 has a buffer function as well as a function for relaying and registering the data. In more precisely, the buffer device 2 can be a data register with reorder function.

To be noted, the buffer device 2 further includes a memory control unit 21. The memory control unit 21 can control the buffer device 2 to retrieve data from the memory 1 or write data into the memory 1. Since the memory access width (or bandwidth) of the memory 1 is limited, the available convolution operations of the convolution operation module 3 is highly related to the access width of the memory 1. In other words, the operation performance of the convolution operation module 3 is limited by the access width. When reaching the bottleneck of the input from the memory, the performance of the convolution operation can be impacted and decreased.

The convolution operation module 3 includes a plurality of convolution units, and each convolution unit executes a convolution operation based on a filter and a plurality of current data. After the convolution operation, a part of the current data is remained for the next convolution operation. The buffer device 2 retrieves a plurality of new data from the memory 1, and the new data are inputted from the buffer device 2 to the convolution unit. The new data are not duplicated with the current data. The convolution unit of the convolution operation module 3 can execute a next convolution operation based on the filter, the remained part of the current data, and the new data. The interleaving sum unit 4 is coupled to the convolution operation module 3 and generates a characteristics output result according to the result of the convolution operation. The sum buffer unit 5 is coupled to the interleaving sum unit 4 and the buffer device 2 for registering the characteristics output result. When the selected convolution operations are finished, the buffer device 2 can write all data registered in the sum buffer unit 5 into the memory 1.

The coefficient retrieving controller 6 is coupled to the convolution operation module 3, and the control unit 7 is coupled to the buffer device 2. In practice, the convolution operation module 3 needs the inputted data and the coefficient of filter for performing the related operation. In this embodiment, the needed coefficient is the coefficient of the 3×3 convolution unit array. The coefficient retrieving controller 6 can directly retrieve the filter coefficient from external memory by direct memory access (DMA). Besides, the coefficient retrieving controller 6 is also coupled to the buffer device 2 for receiving the instructions from the control unit 7. Accordingly, the convolution operation module 3 can utilize the control unit 7 to control the coefficient retrieving controller 6 to perform the input of the filter coefficient.

The control unit 7 includes an instruction decoder 71 and a data reading controller 72. The instruction decoder 71 receives an instruction from the data reading controller 72, and then decodes the instruction for obtaining the data size of the inputted data, columns and rows of the inputted data, the characteristics number of the inputted data, and the initial address of the inputted data in the memory 1. In addition, the instruction decoder 71 can also obtain the type of the filter and the outputted characteristics number from the data reading controller 72, and output the proper blank signal to the buffer device 2. The buffer device 2 can operate according to the information provided by decoding the instruction as well as controlling the operations of the convolution operation module 3 and the sum buffer unit 5. For example, the obtained information may include the clock for inputting the data from the memory 1 to the buffer device 2 and the convolution operation module 3, the sizes of the convolution operations of the convolution operation module 3, the reading address of the data in the memory 1 to be outputted to the buffer device 2, the writing address of the data into the memory 1 from the sum buffer unit 5, and the convolution modes of the convolution operation module 3 and the buffer device 2.

In addition, the control unit 7 can also retrieve the needed instruction and convolution information from external memory by data memory access. After the instruction decoder 71 decodes the instruction, the buffer device 2 retrieves the instruction and the convolution information. The instruction may include the size of the stride of the sliding window, the address of the sliding window, and the numbers of columns and rows of the image data.

The sum buffer unit 5 is coupled to the interleaving sum unit 4. The sum buffer unit 5 includes a partial sum region 51 and a pooling unit 52. The partial sum region 51 is configured for registering data outputted from the interleaving sum unit 4. The pooling unit 52 performs a pooling operation with the data registered in the partial sum region 51. The pooling operation is a max pooling or an average pooling.

For example, the convolution operation results of the convolution operation module 3 and the output characteristics results of the interleaving sum unit 4 can be temporarily stored in the partial sum region 51 of the sum buffer unit 5. Then, the pooling unit 52 can perform a pooling operation with the data registered in the partial sum region 51. The pooling operation can obtain the average value or max value of a specific characteristics in one area of the inputted data, and use the obtained value as the fuzzy-rough feature extraction or statistical feature output. This statistical feature has lower dimension than the above features and is benefit in improving the operation results.

To be noted, the partial operation results of the inputted data are summed (partial sum), and then registered in the partial sum region 51. The partial sum region 51 can be referred to a PSUM unit, and the sum buffer unit 5 can be referred to a PSUM buffer module. In addition, the pooling unit 52 of this embodiment obtains the statistical feature output by above-mentioned average pooling. After inputted data are all processed by the convolution operation module 3 and the interleaving sum unit 4, the sum buffer unit 5 outputs the final data processing results. The results can be stored in the memory 1 through the buffer device 2, and outputted to other components through the memory 1. At the same time, the convolution operation module 3 and the interleaving sum unit 4 can continuously obtain the data characteristics and perform the related operations, thereby improving the process performance of the convolution operation device.

In the above-mentioned average pooling, the original filter coefficients stored in the memory need to be modified, and the data to be inputted to the convolution operation module 3 is the modified factors. The factors can be those used in the integrated operation of the pooling layer and the next convolution layer. To be noted, the generation of the factors has been illustrated in the above embodiment, so the detailed description thereof will be omitted. When the convolution operation device is processing the current convolution layer and the current pooling layer, the pooling unit 52 may not process the division operation portion of the average pooling for the current pooling layer. In this case, the non-processed division operation portion of the average pooling is integrated to the multiplication operation of the convolution operation when the convolution operation device processes the next convolution layer. In addition, when the convolution operation device is processing the current convolution layer and the current pooling layer, the pooling unit 52 may process a part of the division operation by bit-shift operation, and the residual part of the division operation of the average pooling is still not processed yet. Then, the non-processed part of division operation of the average pooling is integrated to the multiplication operation of the convolution operation when the convolution operation device processes the next convolution layer.

The convolution operation device may include a plurality of convolution operation modules 3. The convolution units of the convolution operation modules 3 and the interleaving sum unit 4 can be optionally operated in the low-scale convolution mode or a high-scale convolution mode. In the low-scale convolution mode, the interleaving sum unit 4 is configured to sum results of the convolution operations of the convolution operation modules 3 by interleaving so as to output sum results. In the high-scale convolution mode, the interleaving sum unit 4 is configured to sum the results of the convolution operations of the convolution units as outputs.

In summary, the operation device and method of the disclosure can perform the average pooling operation by two steps. The pooling unit only performs the add operation cooperating with the bit-shift operation so as to prevent the data overflow caused in the accumulating procedure. Then, the weight-scaling operation is applied to the output result of the pooling unit to obtain the final average result. Since the pooling unit does not perform the division operation, the required performance of the processor can be reduced so as to increase the pooling operation efficiency.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An operation method for a convolutional neural network, comprising steps of:
performing an add operation with a plurality of input data to output an accumulated result;
performing a bit-shift operation with the accumulated result to output a shifted result; and
performing a weight-scaling operation with the shifted result to output a weighted result, wherein a weighting factor of the weight-scaling operation is determined according to an amount of the input data, an amount of right-shifting bits in the bit-shift operation, and a scaled weight value of a consecutive layer in the convolutional neural network.

2. The operation method of claim 1, wherein the weighting factor of the weight-scaling operation is proportional to the scaled weight value and the amount of the right-shifting bits in the bit-shift operation, and is inversely proportional to the amount of the input data, and the weighted result is equal to a product of the shifted result and the weighting factor.

3. The operation method of claim 1, wherein the amount of the right-shifting bits in the bit-shift operation depends on a size of a pooling window, and the amount of the input data depends on the size of the pooling window.

4. The operation method of claim 1, wherein the consecutive layer is a next convolution layer in the convolutional neural network, the scaled weight value is a filter coefficient of the next convolution layer, and the add operation and the bit-shift operation are operations in a pooling layer of the convolutional neural network.

5. The operation method of claim 4, wherein a division operation of the pooling layer is integrated in a multiplication operation of the next convolution layer.

6. An operation method for a convolutional neural network, comprising steps of:
performing an add operation with a plurality of input data in a pooling layer to output an accumulated result; and
performing a weight-scaling operation with the accumulated result in a consecutive layer to output a weighted result, wherein a weighting factor of the weight-scaling operation is determined according to an amount of the input data and a scaled weight value of the consecutive layer, and the weighted result is equal to a product of the accumulated result and the weighting factor.

7. The operation method of claim 6, wherein the consecutive layer is a next convolution layer, the scaled weight value is a filter coefficient, the weight-scaling operation is a convolution operation, and the weighting factor of the weight-scaling operation is obtained by dividing the filter coefficient with the amount of the input data.

8. The operation method of claim 6, wherein the amount of the input data depends on a size of the pooling window.

9. An operation method for a convolutional neural network, comprising steps of:
multiplying a scaled weight value and an original filter coefficient to produce a weighted filter coefficient; and
performing a convolution operation with input data and the weighted filter coefficient in a convolution layer.

10. The operation method of claim 9, further comprising steps of:
performing a bit-shift operation with the input data; and
inputting the input data processed by the bit-shift operation to the convolution layer;
wherein the scaled weight value depends on an original scaled weight value and an amount of right-shifting bits in the bit-shift operation.
